(19) United States
(12) Patent Application Publication
(10) Pub. No.: US 2018/0060899 A1
(43) Pub. Date: Mar. 1, 2018

(54) SMART REWARD DISPENSING MACHINE AND REWARD SYSTEM USING THE SAME

(71) Applicant: INTERNATIONAL BUSINESS MACHINES CORPORATION, Armonk, NY (US)

(72) Inventors: Payel Das, Yorktown Heights, NY (US); Sufi Zafar, Briarcliff Manor, NY (US)

(21) Appl. No.: 15/248,959

(22) Filed: Aug. 26, 2016

(51) Int. Cl. G06Q 30/02; G06Q 30/06; G06Q 50/20

(52) U.S. Cl. CPC G06Q 30/0237; G06Q 50/20; G06Q 30/0621

(57) ABSTRACT

A method, a system and devices for dispensing a reward are provided. A reward dispensing machine (RDM) may include one or more reward reservoirs each storing a respective kind of pre-customized reward items or material. The RDM may include a customization unit, as well as a communication unit configured to receive a reward request associated with a recipient and comprising a description of an intended reward. The RDM may include a processor and memory storing a customization script that causes the processor to control the customization unit to produce the intended reward by receiving one of the pre-customized reward items or material from one of the one or more reward reservoirs and customizing the one of the pre-customized reward items or material into the intended reward based on the description of the intended reward. The RDM may include a dispensing unit configured to dispense the intended reward to the recipient.

### BACKGROUND

### Technical Field

The present disclosure generally relates to intelligent machines, and more particularly, to a smart reward dispensing machine capable of dispensing various rewards that are customized for a respective recipient.

### Background

It is generally acknowledged by education theories and practices that a properly designed reward mechanism is helpful in providing an incentive to enhance effective learning and encourage good behaviors. For example, teachers at school, parents at home and coaches of sports often adopt various reward mechanisms, such as giving out prizes, trophies, award certificates or even oral compliments, in enhancing effectiveness of educating or training students, children and athletes. In some cases, a reward is dispensed or otherwise given to a recipient readily after a desired behavior or an assigned task is carried out (i.e., instant gratification). In some cases, a reward may be given to a recipient at a later time when it is more appropriate to either the recipient or a reward giver, or both (i.e., delayed gratification).

Traditionally, an educator (e.g., a teacher, a parent or a coach; hereinafter “a teacher”) is physically present with a potential reward recipient (e.g., a student, a child or an athlete; hereinafter “a student”) so that the educator can assess a performance of the potential reward recipient and decide whether a reward is to be awarded to the recipient. As technology progresses, however, more and more education takes place in a remote environment or scenario, i.e., a teacher may not be physically close to a student. In some cases, a teacher may not even be a human being, and a student may be learning through or from a machine having certain level of intelligence, such as an electronic learning console or a computer.

### SUMMARY

According to an embodiment of the present disclosure, a reward dispensing machine (RDM) is provided. The RDM may include one or more reward reservoirs. Each of the reward reservoirs may store a respective kind of pre-customized reward items or material. The RDM may also include a customization unit. The RDM may further include a communication unit, which may be configured to receive a reward request associated with a recipient. The reward request may include a description of an intended reward to be produced by the customization unit. The RDM may also include one or more processors, as well as memory operably connected to the one or more processors. The memory may store a plurality of components executable by the one or more processors, and the components may include a customization script that is programmed to cause the one or more processors to control the customization unit to produce the intended reward. In particular, the customization unit first receives from the reward reservoirs a pre-customized reward item or material, which is then customized by the customization unit into the intended reward. The customization may be carried out by the customization unit based on the description of the intended reward included in the reward receipt. The RDM may further include a dispensing unit that is configured to dispense the intended reward to the recipient.

According to another embodiment of the present disclosure, a method for dispensing a reward to a recipient is provided. A first reward request associated with a recipient may be received, wherein the first reward request includes a description of a first reward. A second reward different from the first reward may subsequently be determined, and the second reward may be determined based on the first reward request and a list of reward preferences pre-determined by or for the recipient. A description regarding the second reward may be presented to the recipient, and a decision by the recipient may be received indicating whether to replace the first reward request with a second reward request, wherein the second reward request includes the description regarding the second reward. Depending on the decision, either the first reward or the second reward may be dispensed to the recipient.

According to another embodiment of the present disclosure, reward-enhanced learning system is provided. The system may include a learning console through which a student attempts to complete a task. The system may also include a reward dispensing machine having a recipient identification device. The system may further include a smartphone app configured to store a pre-determined list of reward preferences of the student, a task history recording one or more tasks having been completed by the student, and a reward history recording one or more rewards having been dispensed to the student. The learning console is configured to send a completion notification to the smartphone app to indicate a completion of the task by the student when the student completes the task. The smartphone app is configured, after receiving the completion notification, to determine a personalized reward for the student based on the pre-determined list of reward preferences. In addition, the smartphone app is configured to request a permission to dispense the personalized reward to the student from a user of a smartphone executing the smartphone app. Furthermore, the smartphone app is configured to send a dispensing request to the reward dispensing machine after receiving the permission. After receiving the dispensing request, and when the recipient identification device identifies a physical presence of the student within a proximity of the reward dispensing machine, the reward dispensing machine is configured to dispenses the personalized reward to the student.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of an example apparatus that can customize and dispense a reward to an identified recipient, consistent with an exemplary embodiment.

FIG. 2 illustrates an example reward request received by the example apparatus of FIG. 1, consistent with an exemplary embodiment.

FIG. 3 illustrates an example recipient profile stored within and utilized by the example apparatus of FIG. 1, consistent with an exemplary embodiment.

FIG. 4 illustrates an example process that dispenses a customized reward to a recipient, consistent with an exemplary embodiment.

FIG. 5 illustrates an example system that dispenses a customized reward to a recipient, consistent with an exemplary embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The present disclosure generally relates to intelligent machines and, more particularly, to a smart reward dispensing machine capable of dispensing various rewards that are customized for a respective recipient. According to various embodiments disclosed herein, a reward that is customized to fit a specific need or preference of a recipient may be produced. That is, a pre-customized or commodity reward item or material may be customized into a specialized or otherwise personalized reward according to a reward description that is tailored toward the specific need or preference of the recipient. The recipient may be entitled to receive the reward because he or she has completed certain tasks. In one embodiment, an approval may be obtained before the recipient is entitled to a reward for a completed task. The approval may be determined by comparing the completed task with a list of goals pre-determined for the recipient. In one embodiment, the recipient may choose, instead of receiving the reward, to exchange a right of claiming the reward with some reward credit, which may be accumulated in a reward account of the recipient. The credit in, or otherwise a balance of, the reward account of the recipient may be redeemed, either in part or in full, for a different reward at a later time. Reference now is made in detail to the examples illustrated in the accompanying drawings and discussed below.

### Example Apparatus

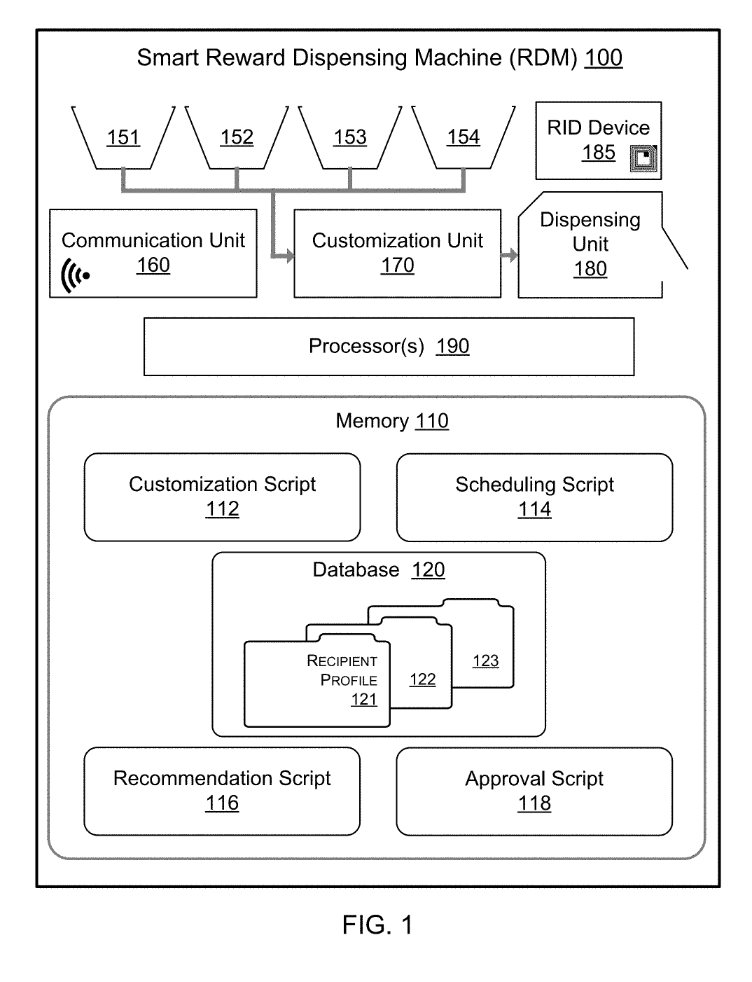

FIG. 1 is a block diagram of an example apparatus that can customize and dispense a reward to a recipient, consistent with an exemplary embodiment. Specifically, FIG. 1 shows a reward dispensing machine (RDM) 100 that includes reward reservoirs 151, 152, 153 and 154. Each of the reward reservoirs 151-154 may store a respective kind of pre-customized reward items or material. Notably, pre-customized reward items stored in a reward reservoir are commodity items, identical to each other without substantial differences in appearance, such as, for example and not limited to, blank stickers or blank T-shirts (may be of different sizes) without individual names printed thereon. Similarly, a pre-customized reward material stored in a reward reservoir is homogeneous by itself, such as, for example and not limited to, sugar, food color, a pizza dough or a 3-dimensional (3D) printing material consumable by a 3D printer. Although FIG. 1 shows that RDM 100 has 4 reward reservoirs, it is to be noted that reward reservoirs 151-154 just serve as an exemplary illustration of the present disclosure, and a RDM consistent with the present disclosure may have a different number of reward reservoirs therein.

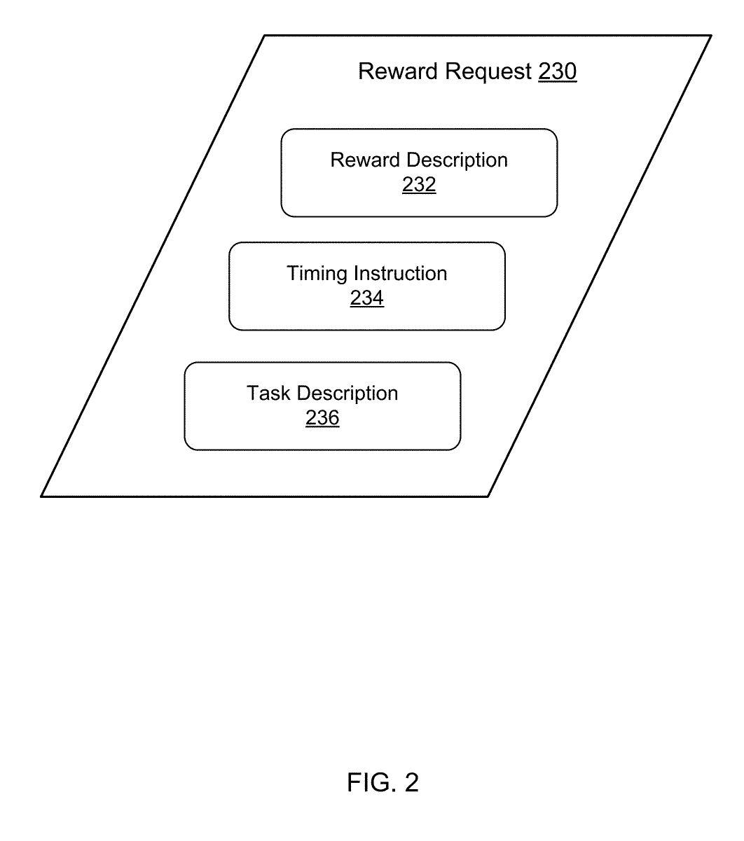

RDM 100 also includes a customization unit 170 that is able to receive a pre-customized item or material from reward reservoirs 151-154, and subsequently customize the received item or material into an intended reward according to certain customization instructions. In one embodiment, in order to produce an intended reward, customization unit 170 may receive more than one kind of pre-customized item or material from more than one of reward reservoirs 151-154. The customization instructions may be included in, or otherwise inferred from, a description of the intended reward, and the description of the intended reward is in turn included in a reward request sent to and utilized by RDM 100. The reward request is associated with an intended recipient of the reward, and may be sent to RDM 100 from a separate device that is configured to communicate with RDM 100. Neither of the reward request, the description of the intended reward and the customization instructions are shown in FIG. 1. FIG. 2 illustrates an example reward request 230 that may be received by RDM 100 through communication unit 160. More details of reward request 230 will be given in a later part of the present disclosure.

In one embodiment, RDM 100 of FIG. 1 may include a communication unit 160, and RDM 100 may receive the reward request associated with the recipient through communication unit 160. In one embodiment, communication unit 160 may be capable of communicating wirelessly with another object or person, which may be located remotely away from RDM 100. For example, RDM 100 may be located in a hallway of a school, and communication unit 160 may be able to wirelessly receive the reward request transmitted from a personal computer or a tablet computer located in a classroom of the school. In one embodiment, communication unit 160 may be configured to communicate with a person located within a proximity of RDM 100. For example, communication unit 160 may be configured to communicate with a student, who is the recipient of the reward, by taking inputs from and giving outputs to the student. To realize this function, communication unit 160 may include various human interface devices such as a display, a keyboard, a pointing device (e.g., a computer mouse), a touchscreen, a speaker, a microphone, a motion sensor, a transponder, etc.

In one embodiment, RDM 100 may include a processor 190 and memory 110. Memory 110 may be operably connected to or otherwise accessible by processor 190, and may be configured to store one or more computer software components, or “scripts”, for execution by processor 190. In one embodiment, memory 110 may store data, codes and/or instructions pertaining to or otherwise defining one or more components shown in FIG. 1 such as, for example, customization script 112. In one embodiment, customization script 112 may be executed by processor 190 to infer the customization instructions from the description 232 of the intended reward that is included in the reward request 230 received by RDM 100. In addition, customization script 112 may be executed by processor 190 to control customization unit 170 to produce the intended reward based on the customization instructions.

In one embodiment, RDM 100 may also include a dispensing unit 180 that is configured to dispense the intended reward produced by customization 170 to a recipient. In one embodiment, RDM 100 may further include a recipient identification (RID) device 185 such as, for example and not limited to, a radio-frequency identification (RFID) transponder, a fingerprint scanner, a facial recognition device, a speech recognition device, an ID card scanner, a credit card scanner, an infrared scanner, or the like. The RID device 185 may be configured to identify an identification of the recipient. Specifically, the recipient of the reward may be identified by RDM 100 through RID device 185 when he or she is physically present within a proximity of RDM 100. Upon identifying the identification of the recipient, dispensing unit 180 may be configured to dispense the reward produced by customization unit 170 to the recipient. For example, dispensing unit 180 may have one or more compartments each having a locked door. A reward produced by customization unit 170 may be temporarily stored in one of the compartments of dispensing unit 180, and the door of the compartment is unlocked when RID device 185 identifies an identification of the intended recipient. Accordingly, the employment of RID device 185 may assist in ensuring a reward be dispensed to a recipient who is the intended person to receive the reward.

As shown in FIG. 2, reward request 230 may include reward description 232 that describes an intended reward to be produced by customization unit 170 and subsequently dispensed to an intended recipient by dispensing unit 180. For example, customization unit 170 may be a sticker printer, and reward request 230 may be associated with a student named Johnny, who is the intended recipient. Reward description 232 may describe the intended reward to be 3 stickers of a size of 2″×1″ and each printed with a label that reads “Johnny Rocks!!” in blue color and italic font. Received as part of reward request 230 by RDM 100 through communication unit 160 thereof, reward description 232 having such description may be utilized by processor 190 executing customization script 112. In particular, processor 190 executing customization script 112 may infer one or more customization instructions (e.g., a series of processing steps), and accordingly control customization unit 170 (i.e., the sticker printer) to produce the intended reward (i.e., 3 stickers of 2″×1″, each printed with a label that reads “Johnny Rocks!!” in blue color and italic font). That is, the sticker printer may be controlled by processor 190 to receive from reservoir 151 of RDM 100 a blank sticker paper having a plurality of 2″×1″ blank sticker. The printed stickers may be temporarily stored in dispensing unit 180, and dispensing unit 180 may dispense the 3 printed stickers to Johnny when RID device 185 identifies that Johnny is present at RDM 100 to collect his stickers as reward.

As another example, customization unit 170 may be a 3D printer, and reward request 230 may be associated with a child named Amy, who is the intended recipient. Reward description 232 may describe the intended reward to be one 3D figure of red color having a ladybug shape and a size of 1″×0.5″×0.3″. Received as part of reward request 230 by RDM 100 through communication unit 160 thereof, reward description 232 having such description may be utilized by processor 190 executing customization script 112. In particular, processor 190 executing customization script 112 may infer one or more customization instructions (e.g., a series of processing steps), and accordingly control customization unit 170 (i.e., the 3D printer) to produce the intended reward (i.e., a 3D figure of red color having a ladybug shape and a size of 1″×0.5″×0.3″). That is, the 3D printer may be controlled by processor 190 to receive from reservoir 152 of RDM 100 a length of fifty centimeters of red filament consumable by the 3D printer. The 3D printer may turn the piece of red filament into a 3D ladybug as described in Reward description 232, and dispensing unit 180 may subsequently dispense the 3D ladybug figure to Amy.

In one embodiment, reward request 230 may, in addition to reward description 232, further include a timing instruction 234, as shown in FIG. 2. Moreover, memory 110 may further include a scheduling script 114, which may be executed by processor 190. Received as part of reward request 230 by RDM 100 through communication unit 160 thereof, timing instruction 234 may be utilized by processor 190 executing scheduling script 114. In particular, processor 190 executing scheduling script 114 may control dispensing unit 180 to dispense the intended reward at a specific time or during a specific period of time based on the timing instruction. For example, in the above example of the child Amy, RDM 100 located at Amy's home may receive reward request 230 regarding Amy at 3:00 pm. It may take the 3D printer about 30 minute to produce the 3D ladybug figure. However, Amy may be going to a park at 3:10 pm and will not come home until 4:00 pm. Were the reward (i.e., the 3D ladybug figure) to be dispensed by dispensing unit 180 immediately after the reward is produced by customization unit 170 (i.e., the 3D printer), which is around 3:30 pm, Amy would not be home to receive the reward, and Amy's dog may snatch away the unattended ladybug figure and chew on it. On the other hand, in a case in which reward request 230 includes timing instruction 234, timing instruction 234 may instruct RDM 100 not to dispense the 3D ladybug figure until 3:35 pm, or during 3:35 pm and 3:40 pm, when Amy has returned home from the park to receive her reward.

In one embodiment, when the intended reward is edible, drinkable, wearable or otherwise consumable by the recipient, scheduling script 114 may be further programmed to cause processor 190 to control customization unit 170 to produce the intended reward at a time prior to the specific time or the specific period of time indicated by timing instruction 234. This is for the purpose that the intended reward may be in a desired condition at the specific time or during the specific period of time. For example, the intended reward may be a dozen cupcakes to be served to a group of children at 11:00 AM for a birthday party. It may be desired that the cupcakes be cooled off for 15 minutes before being served. Timing instruction 234 may thus include an instruction that the cupcakes be ready to serve at 11:00 AM. Based on this information contained in timing instruction 234, scheduling script 114 may be programmed to cause processor 190 to control customization unit 170 (e.g., a cupcake maker) to produce the dozen cupcakes at 10:45 AM so that the cupcakes may be in a desired condition (e.g., fresh but not too hot for the children) when served to the children at 11:00 AM.

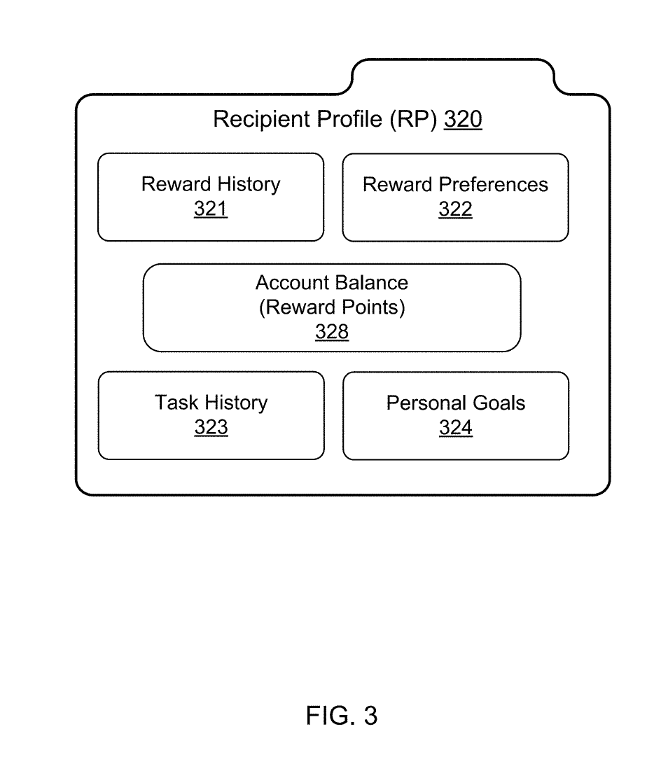

RDM 100 may serve more than one reward recipient, and it may be advantageous to keep a history of rewards requested by or for each recipient, as well assign rewards actually dispensed to each recipient. To realize this function, in one embodiment, memory 110 may also include a database 120, and database 120 may have one or more recipient profiles, such as recipient profiles 121, 122 and 123, as shown in FIG. 1. Each recipient profile (RP) of recipient profiles 121, 122 and 123 may be associated with a respective recipient. Following the above examples of Johnny and Amy, database 120 may have a RP for Johnny, and a separate RP for Amy. Each RP of RPs 121-123 of FIG. 1 may have a data structure that is the same as RP 320 in FIG. 3. Namely, each RP stored in database 120 may include a reward history 321 that records all the reward requests associated with the respective recipient, as well as all the rewards actually dispensed to the respective recipient. Reward history 321 also includes respective timestamps indicating when each reward request recorded therein has been received by RDM 100. Similarly, reward history 321 may also include respective timestamps indicating when each reward has been dispensed by dispensing unit 180 to the respective recipient associated with RP 320.

In one embodiment, RP 320 may further include a list of reward preferences 322 associated with the respective recipient. The list of reward preferences 322 may be pre-determined by or for the respective recipient. For example, Johnny may have the following list of reward preferences 322 included in his respective RP: “cars, blue, black, italic, sports, stickers, candy, baseball, cartoon.” Amy may have the following list of reward preferences 322 included in her respective RP: “insects, red, pink, purple, figures, animals, sweets, mommy, chocolate.” The purpose of including the list of reward preferences 322 in RP 320 will be disclosed as described below.

In one embodiment, memory 110 of RDM 100 may include recommendation script 116, as shown in FIG. 1. When executed by processor 190, recommendation script 116 may be configured to cause processor 190 to generate a reward recommendation for a recipient based on the respective RP associated with the recipient. The reward recommendation may include one or more recommended rewards that are different from a reward indicated by the reward request. For example, RDM 100 may receive a first reward request indicating a blue sticker is to be produced and dispensed to Johnny. Recommendation script 116 may cause processor 190 to generate a reward recommendation based on Johnny's RP 320. Specifically, processor 190 may execute recommendation script 116 and find that Johnny has just received 3 blue stickers, as recorded in reward history 321 of Johnny's RP 320. Recommendation script 116 may further cause processor 190 to generate the reward recommendation according to reward preferences 322 of Johnny's RP 320, and the reward recommendation may recommend Johnny to get a sticker having a black race car printed thereon instead of another blue sticker as originally indicated in reward request 230. The reward recommendation may be presented to Johnny via communication unit 160, and Johnny may subsequently make a decision regarding whether to reject the reward recommendation and still get another blue sticker, or to accept the reward recommendation and get the black race car sticker instead. If Johnny decides to still get another blue sticker, as indicated by the first reward request, the decision may be received by RDM 100 through communication unit 160 indicating so. Alternatively, if Johnny decides to get the black race car instead, the decision may be substantiated by a second reward request having a description of the black race car sticker. The second reward request may be received by RDM 100 through communication unit 160. In either case, RDM 100 may produce the reward intended by Johnny (i.e., either the blue sticker or the black race car sticker) according to the decision, and dispensing unit 180 may dispense the intended reward to Johnny as described above. In one embodiment, as disclosed earlier, either or both of the first and the second reward requests may further include a respective timing instruction so that the intended reward may be disposed to Johnny at a specific time or during a specific period of time based on the timing instruction.

Instead of physically tangible objects or prizes, RDM 100 may also dispense or otherwise deliver rewards that are virtual, such as an encouragement sentence shown in a display of communication unit 160, or some virtual reward points or credits. The virtual reward points earned by a recipient may be accumulated as an account balance associated with the recipient, and may be redeemed or exchanged for some physical rewards or prizes at a later time. In one embodiment, RP 320 may include an account balance 328 associated with the respective recipient of the recipient profile, as shown in FIG. 3. Reward description 234 of reward request 230 associated with a recipient may be a certain number of reward points, and the reward points may be accumulated in account balance 328 of RP 320 associated with the recipient. For example, Johnny may have an account balance 238 of twelve reward points as recorded in his RP 320. A reward request 230 associated with Johnny and having a reward description 232 describing a virtual reward of three reward points may be received by RDM 100, and the virtual reward of three reward points may be dispensed to Johnny by accumulating the three reward points in Johnny's account balance 238 as recorded in his RP 320, resulting in a total number of 12+3=15 reward points as account balance 238 after the dispensing. Johnny may, at a later time, choose to redeem part or all of the 15 reward points in his account balance 238 for some physical reward that he desires.

For the purpose of enhancing learning effectiveness or promoting good behavior of recipient, such as a student or a child, a reward request is often associated with one or more completed tasks that are completed by the recipient. Namely, the reward request is often a consequence of a task completed by the recipient, so as to serve as an incentive for the recipient to repeat the same task or attempt another task. Therefore, it is advantageous to keep a record of the one or more completed tasks associated with the reward request. In one embodiment, reward request 230 may, as shown in FIG. 2, further include task description 236 that describes one or more completed tasks associated with reward request 230. Alternatively, task description 236 may not be included in reward request 230 along with reward description 232 and timing instruction 234. That is, RDM 100 may receive task description 236 and reward description 232 from two different objects or sources. In either case, task description 236 may be received by RDM 100 through communication unit 160.

When a reward request is associated with one or more tasks completed by the recipient, RDM 100 may be equipped with a mechanism to record the one or more completed tasks. In one embodiment, RP 320 of a recipient may include task history 323, as shown in FIG. 3, that is configured to record tasks that have been completed by the recipient. For example, RP 320 associated with Johnny may include task history 323 that records both a description of one or more tasks completed by Johnny, as well as a timestamp showing when each task thereof has been completed. In one embodiment, RP 320 may keep a 1-to-1 correspondence (not shown in FIG. 3) between reward history 321 and task history 323.

In one embodiment, RP 320 may further include personal goals 324, which is a list of goals the respective student/recipient is trying to achieve and/or master. Moreover, recommendation script 116 may be programmed to cause processor 190 to generate a task recommendation based on RP 320. That is, based on task history 323 and personal goals 324, RDM 100 may generate one or more recommended tasks for the recipient to complete. For example, Johnny may be in the process of learning and mastering skills of multiplication. Thus, personal goals 324 for Johnny, as included in Johnny's RP 320, may include goals such as (i) memorizing multiplication table; (ii) 2-digit and 1-digit multiplication; (iii) 2-digit and 2-digit multiplication; and (iv) 3-digit and 3-digit multiplication. When executing recommendation script 116, processor 190 of RDM 100 may check task history 323 and find that Johnny has recently completed several exercises on multiplication table and 2-digit and 1-digit multiplication, but have not completed much of exercise on 2-digit and 2-digit multiplication, let alone 3-digit and 3-digit multiplication. Therefore, recommendation script 116 may cause processor 190 to generate a task recommendation that suggests Johnny to work on some 2-digit and 2-digit multiplication exercise as a next step of learning multiplication. The task recommendation may be presented to Johnny through communication unit 160 of RDM 100. In one embodiment, the task recommendation may further include a respective number of reward points for each of the recommended tasks in the task recommendation. For example, the task recommendation for Johnny may be “complete 5 problems of 2-digit and 2-digit multiplication to get 10 reward points if you get the correct answer on 4 out of the 5 problems.” The 10 reward points associated with the recommended task may provide Johnny an incentive to practice and master his multiplication skills.

To ensure that a student is learning what he or she is supposed to learn and/or has achieved a certain standard of learning, RDM 100 may receive a permission from an approver (e.g., a teacher or a tutor) before producing an intended reward as described in reward description 232 of reward request 230. In one embodiment, RDM 100 may receive, through communication unit 160, task description 236 as part of reward request 230. RDM 100 may subsequently transmit, also through communication unit 160, task description 236 to the approver. The approver may decide whether or not the one or more tasks completed by the student, as described in task description 236, has qualified the student to be entitled for the intended reward as described in reward description 232. For example, Johnny may have finished five 2-digit and 2-digit multiplication problems at home and get all the 5 answers correct, as described in task description 236 of reward request 230. RDM 100 may transmit task description 236 to Johnny's teacher who is located at school, and the teacher may decide, based on the task description received from RDM 100, that Johnny is entitled for a reward. The teacher may send a permission to RDM 100 indicating that Johnny is entitled to receive the reward. With the permission from the teacher received, RDM 100 may produce the reward according to reward request 230 and dispense the reward to Johnny. In one embodiment, the task recommendation generated by recommendation script 116 for Johnny may also be sent to the approver for reference or for approval.

In one embodiment, RDM 100 may not resort to a human approver to receive a permission that indicates an approval of a reward request 230, as described above. Instead, memory 110 of RDM 100 may include approval script 118 that may serve the purpose of approving reward request 230. Specifically, approval script 118 may approve or reject reward request 230 based on a combined consideration of task description 236 and personal goals 324. That is, if the completed task by the recipient, as described in task description 236, matches one of the personal goals of the recipient, as listed in personal goals 324, approval script 118 may approve reward request 230. Otherwise, approval script 118 may reject reward request 230.

As mentioned above, a recipient may redeem part or all of the reward points in his or her account balance for a reward. To redeem reward points for a reward, the recipient may initiate reward request 230 that is to be received by RDM 100. The reward request 230 may include reward description 232, and may further include timing instruction 234, but will not include task description 236, as redeeming rewards with reward points does not require the recipient completing a task. Moreover, the intended reward as described or otherwise indicated by reward description 232 may be associated with a value of the intended reward that is represented by a respective number of reward points. In one embodiment, approval script 118 may approve or reject reward request 230 based on a combined consideration of the value of the intended reward and account balance 328 of the recipient. That is, if the value of the intended reward, in number of reward points, is lower or equal to account balance 328, also in number of reward points, then approval script 118 may approve reward request 230. Otherwise, script 118 may reject reward request 230. After approval script 118 approves reward request 230, processor 190 is configured to control customization unit 170 to produce the intended reward.

In one embodiment, even if what is described by reward description 234 is a physical reward, reward description 234 may be associated with an equivalent value of the physical reward, manifested in a number of reward points, of the physical reward. Recommendation script 116 may then be programmed to, through generating a reward recommendation, suggest the recipient to choose to save the number of reward points of equivalent value into account balance 328 associated with the recipient, instead of receiving the physical reward from RDM 100. It is to be noted that the association of the equivalent value with the physical reward may be carried out by RDM 100, such as by recommendation script 116 thereof, or by some other device or database outside RDM 100. For example, a reward request 230 associated with Johnny may include reward description 232 describing 3 pieces of candy. Recommendation script 116 may associate the three pieces of candy with an equivalent value of 6 reward points, and recommend Johnny to increase his account balance 238 by 6 reward points instead of getting the 3 pieces of candy as originally requested in reward request 230.

### Example Processes

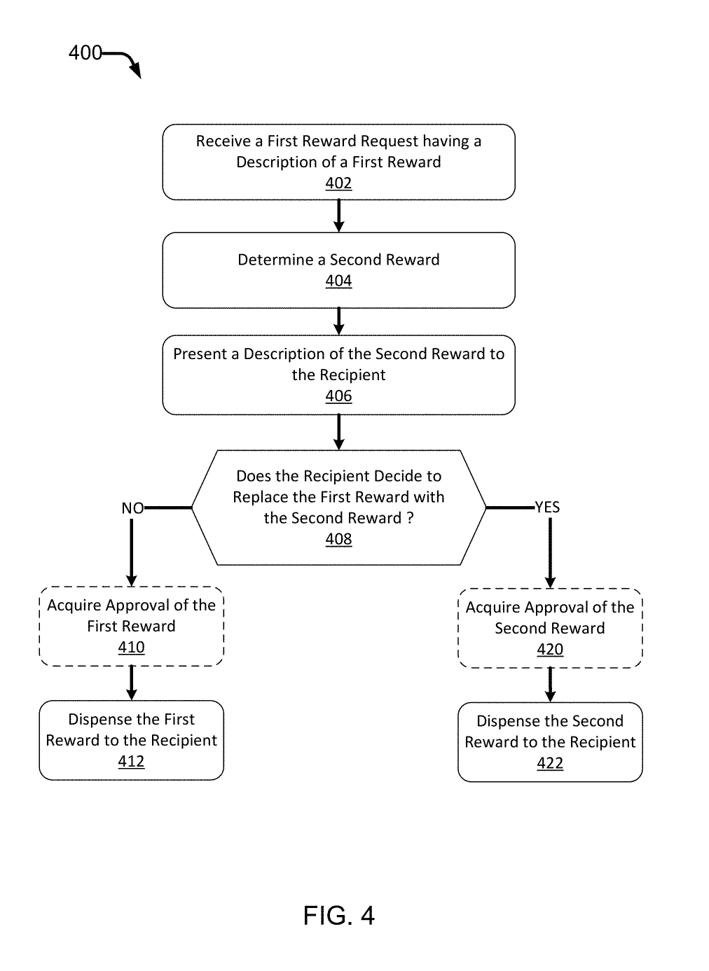

With the foregoing overview of RDM 100, it may be helpful now to consider a high-level discussion of example processes. To that end, FIG. 4 presents an illustrative process 400 for various aspects of dispensing a reward to a recipient. Process 400 is illustrated as a collection of blocks in logical flowcharts, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or performed in parallel to implement the process. For discussion purposes, process 400 is described with reference to RDM 100 of FIG. 1, reward request 230 of FIG. 2, as well as recipient profile 320 of FIG. 3.

FIG. 4 describes an example process to dispense a reward to a recipient. At block 402, RDM 100 receives, via communication 160 thereof, a first reward request associated with the recipient. The first reward request has a data structure of reward request 230, and includes a description of a first reward, such as reward description 232. In one embodiment, the first reward request also includes a first timing instruction, such as timing instruction 234. In one embodiment, the first reward is a first number of reward points. In one embodiment, the description of the first reward is associated with a value of the first reward represented by the first number of reward points. In one embodiment, the first reward request is further associated with one or more tasks completed by the recipient. The process continues with block 404.

At block 404, RDM 100 determines a second reward that is different from the first reward. The determining of the second reward is based on the first reward request and also based on a list of reward preferences pre-determined by or for the recipient, such as reward preferences 322. In one embodiment, the second reward is a second number of reward points. The process continues with block 406.

At block 406, RDM 100 presents to the recipient, via communication 160 thereof, a description of the second reward similar to reward description 232. In one embodiment, the description of the second reward is associated with a value of the second reward represented by a second number of reward points. The process continues with block 408.

At block 408, RDM 100 receives, via communication 160 thereof, a decision from the client regarding whether the client is to replace the first reward request with a second reward request. The second reward request has a data structure similar to reward request 230, and includes a description of the second reward. In one embodiment, the second reward request also includes a second timing instruction similar to timing instruction 234.

Upon determining that the recipient decides not to replace the first reward request with the second reward request (i.e., “NO” at decision block 408), the process continues with block 412, where RDM 100 dispenses the first reward to the recipient through dispensing unit 180 of RDM 100. In one embodiment, RDM 100 dispenses the first reward to the recipient at a specific time or during a specific period of time based on the first timing instruction. In one embodiment, where the first reward is the first number of reward points, RDM 100 dispenses the first reward to the recipient by adding the first number of reward points to an account balance of reward points, such as account balance 328, that has been earned by the recipient.

In one optional embodiment, the process continues from block 408 to block 410 before further continuing with block 412. At block 410, RDM 100 acquires an approval approving the first reward is to be dispensed to the recipient. In one embodiment, where the description of the first reward is associated with a value of the first reward represented by a number of reward points, the approval is determined based on a combined consideration of the value of the first reward and an account balance of reward points, such as account balance 328, that has been earned by the recipient. In one embodiment, where the first reward request is further associated with one or more tasks completed by the recipient, the approval is determined based on the one or more completed tasks.

Returning to block 408, upon determining that the recipient decides to replace the first reward request with the second reward request (i.e., “YES” at decision block 408), the process continues with block 422, where RDM 100 dispenses the second reward to the recipient through dispensing unit 180 of RDM 100. In one embodiment, RDM 100 dispenses the second reward to the recipient at a specific time or during a specific period of time based on the second timing instruction. In one embodiment, where the second reward is the second number of reward points, RDM 100 dispenses the second reward to the recipient by adding the second number of reward points to an account balance of reward points, such as account balance 328, that has been earned by the recipient.

In one optional embodiment, the process continues from block 408 to block 420 before further continuing with block 422. At block 420, RDM 100 acquires an approval approving the second reward is to be dispensed to the recipient. In one embodiment, where the description of the second reward is associated with a value of the second reward represented by a number of reward points, the approval is determined based on a combined consideration of the value of the second reward and an account balance of reward points, such as account balance 328, that has been earned by the recipient.

### Example System

In view of the teachings herein, one skilled in the art may realize a reward-enhanced learning system by RDM 100 along with a separate device configured to send a reward request associate with a recipient. Furthermore, process 400 may be readily implemented by such a reward-enhanced learning system. The realization of the system, however, would require “intelligence” to be built into the “smart” RDM 100, such as various components stored in memory 110 of FIG. 1, including various components of RP 121, RP 122 and RP 123, as illustrated in FIG. 3.

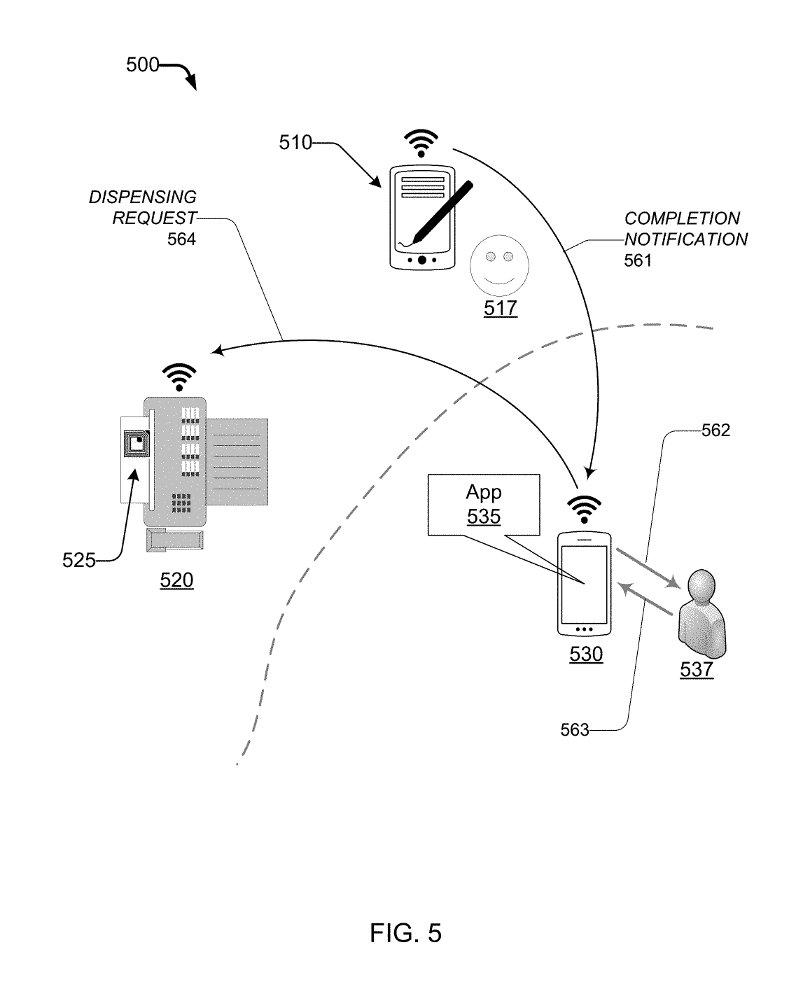

An alternative approach to realize another reward-enhanced learning system may reside in leveraging a smartphone. To that end, FIG. 5 illustrates a reward-enhanced learning system 500 that includes a smartphone 530, which runs or otherwise executes a smartphone app 535 stored therein. In principle, every component stored in memory 110 of RDM 100 may be implemented in smartphone app 535. That is, various components, as illustrated in FIGS. 1 and 3, may be removed from RDM 100 and instead implemented using smartphone app 535. The components that may be removed include customization script 112, scheduling script 114, recommendation script 116, approval script 118, database 120 having a plurality of recipient profiles 121, 122 and 124, as well as reward history 321, reward preferences 322, task history 323, personal goals 324 and account balance 327 of each respective recipient profile in database 120. In addition to smartphone 530 and smartphone app 535, reward-enhanced learning system 500 may further include an electronic learning console 510 used by a student 517, as well as a RDM 520. RDM 520 may be similar to RDM 100 of FIG. 1 except for the various components now implemented in smartphone app 535. In fact, RDM 520 may include every component of RDM 100 except for memory 110 and the various components thereof.

Referring to system 500 of FIG. 5, in one embodiment, smartphone app 535 may store a pre-determined list of reward preferences of student 517 that is similar to reward preferences 322 of recipient profile 320 as shown in FIG. 3. In one embodiment, smartphone app 535 may also store a task history similar to task history 323 of RP 320, and the task history may keep records of one or more tasks that have been completed by student 517. In one embodiment, smartphone app 535 may further store a reward history similar to reward history 321 of RP 320, and the reward history may keep records of one or more rewards hat have been dispensed to student 517.

Reward-enhanced learning system 500 of FIG. 5 may operate as described below: Student 517 may attempt to complete a task of learning through working with learning console 510. Upon student 517 completing the task through learning console 510, learning console 510 may send a completion notification 561 to smartphone 530 indicating that the task has been completed by student 517. In one embodiment, completion notification 561 may include a description of the task, a timestamp of the completion of the task, as well as who has completed the task of learning (i.e., student 517).

After smartphone 530 receives completion notification 561, smartphone app 535 may determine a personalized reward for student 517 to reward him or her for completing the task. The personalized reward may be determined based on the pre-determined list of reward preferences stored in smartphone app 535. After the personalized reward for student 517 is determined, smartphone app 535 may send a request 562 to a user 537 of smartphone 530, asking a permission 563 from a user 537 to dispense the personalized reward to student 517. User 537 may grant permission 563 to smartphone app 535 through smartphone 530, and smartphone app 535 may subsequently send a dispensing request 564 through smartphone 530 to RDM 520.

After RDM 520 receives dispensing request 564 from smartphone app 535 through smartphone 530, RDM 520 produce the personalized reward, and then dispense the personalized reward to student 517 when RID device 525 identifies a physical presence of student 517 within a proximity of RDM 520.

In some embodiments, user 537 may be a parent or a teacher of student 517, and may be located remotely away from student 517. However, with the help of system 500, user 537 is enabled to monitor the learning of student 517 and even provide a personalized reward to student 517 as an incentive to enhance an effectiveness of learning of the student, let along the location of user 537 being remotely away from student 517.

In some embodiments, student 517 may be home-schooled, and user 537 may be a peer student of student 517, who is also home-schooled. Although working on their homework at their respective homes, user 537 and student 517 may enjoy a pseudo peer learning environment made possible via system 500. The peer-to-peer real-time feedback and encouragement enabled by system 500 not only enhance the effectiveness of learning, but also make the learning more fun.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to flowchart illustrations and/or block diagrams of methods, apparatus (systems), and computer program products according to embodiments of the application. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A reward dispensing machine, comprising:
one or more reward reservoirs each storing a respective kind of pre-customized reward items or material;
a customization unit;
a communication unit configured to receive a reward request associated with a recipient, the reward request comprising a description of an intended reward;
one or more processors;
memory operably connected to the one or more processors, the memory storing a plurality of components executable by the one or more processors, the plurality of components comprising:
a customization script programmed to cause the one or more processors to control the customization unit to produce the intended reward by receiving one of the pre-customized reward items or material from one of the one or more reward reservoirs and customizing the one of the pre-customized reward items or material into the intended reward based on the description of the intended reward; and
a dispensing unit configured to dispense the intended reward to the recipient.

2. The reward dispensing machine of claim 1, wherein:
the customization unit comprises a sticker printer,
the pre-customized reward items or material comprise a blank sticker paper,
the description of the intended reward comprises a pattern, one or more colors of the pattern, a pattern size and a reward quantity, and
the intended reward comprises one or more stickers of the reward quantity, each sticker having the pattern of the pattern size printed on the blank sticker paper with the one or more colors of the pattern.

3. The reward dispensing machine of claim 1, wherein:
the customization unit comprises a 3-dimensional (3D) printer,
the pre-customized reward items or material comprise a material consumable by the 3D printer,
the description of the intended reward comprises a 3D shape, a reward color, a reward size and a reward quantity, and
the intended reward comprises one or more 3D figures of the reward quantity, each 3D figure having the 3D shape of the reward color and the reward size.

4. The reward dispensing machine of claim 1, wherein:
the reward request further comprises a timing instruction, and
the plurality of components further comprise a scheduling script programmed to cause the one or more processors to control the dispensing unit to dispense the intended reward at a specific time or during a specific period of time based on the timing instruction.

5. The reward dispensing machine of claim 4, wherein the intended reward is edible, drinkable, wearable or consumable by the recipient, and wherein the scheduling script is further programmed to cause the one or more processors to control the customization unit to produce the intended reward at a time prior to the specific time or the specific period of time such that the intended reward is in a desired condition at the specific time or during the specific period of time.

6. The reward dispensing machine of claim 1, further comprising:
a recipient identification device configured to identify an identification of the recipient,
wherein the dispensing unit is configured to dispense the intended reward when the recipient identification device identifies the identification of the recipient, the identification of the identification of the recipient indicating a physical presence of the recipient within a proximity of the reward dispensing machine.

7. The reward dispensing machine of claim 1, wherein the plurality of components further comprise:
a database comprising one or more recipient profiles, each of the one or more recipient profiles associated with a respective recipient and having a reward history, a list of reward preferences, an account balance of reward points, or a combination of two or more thereof, associated with the respective recipient, wherein:
one of the one or more recipient profiles is associated with the recipient, and
the reward history of the one of the one or more recipient profiles comprises at least one of: (i) a record of the reward request, and (ii) a record of the dispensing unit dispensing the intended reward.

8. The reward dispensing machine of claim 7, wherein the plurality of components further comprise:
a recommendation script programmed to cause the one or more processors to generate a reward recommendation based on the one of the one or more recipient profiles, the reward recommendation comprising one or more recommended rewards different from a reward indicated by the reward request,
wherein the reward recommendation is presented to the recipient via the communication unit.

9. The reward dispensing machine of claim 1, wherein:
the reward request is further associated with one or more tasks completed by the recipient,
the communication unit is further configured to receive a description of the one or more completed tasks, and
the plurality of components further comprise:
a database comprising one or more recipient profiles, each of the one or more recipient profiles associated with a respective recipient and having a task history, a list of goals, an account balance of reward points, or a combination of two or more thereof, associated with the respective recipient, wherein:
one of the one or more recipient profiles is associated with the recipient, and
the task history of the one of the one or more recipient profiles comprises a record of the one or more completed tasks.

10. The reward dispensing machine of claim 9, wherein the plurality of components further comprise:
a recommendation script programmed to cause the one or more processors to generate a task recommendation based on the one of the one or more recipient profiles, the task recommendation comprising one or more recommended tasks for the recipient to complete,
wherein the task recommendation is presented to the recipient via the communication unit.

11. The reward dispensing machine of claim 10, wherein the task recommendation further comprises a respective number of reward points for each of the one or more recommended tasks.

12. The reward dispensing machine of claim 1, wherein the one or more processors are configured to control the customization unit to produce the intended reward after the communication unit receives a permission from an approver, the permission indicating an approval by the approver of the reward request.

13. The reward dispensing machine of claim 12, wherein:
the reward request is further associated with one or more tasks completed by the recipient, and
the communication unit is further configured to receive a description of the one or more completed tasks and transmit the description of the one or more completed tasks to the approver.

14. The reward dispensing machine of claim 1, wherein:
the description of the intended reward is associated with a value of the intended reward represented by a respective number of reward points, and
the plurality of components further comprise:
a database comprising a recipient profile associated with the recipient, the recipient profile comprising an account balance of reward points that have been earned by the recipient; and
an approval script programmed to approve or reject the reward request based on a combined consideration of the value of the intended reward and the account balance,
wherein the one or more processors are configured to control the customization unit to produce the intended reward after the approval script approves the reward request.

15. A method for dispensing a reward to a recipient, comprising:
receiving a first reward request associated with a recipient, the first reward request comprising a description of a first reward;
determining a second reward different from the first reward based on the first reward request and a list of reward preferences pre-determined by the recipient;
presenting a description of the second reward to the recipient;
receiving a decision from the recipient whether to replace the first reward request with a second reward request, the second reward request comprising the description of the second reward; and
dispensing the reward to the recipient, the reward indicated by either the first reward request or the second reward request depending on the decision.

16. The method of claim 15, wherein:
either or both of the first and the second reward requests further comprise a respective timing instruction, and
the dispensing of the reward to the recipient comprises dispensing the reward to the recipient at a specific time or during a specific period of time based on the timing instruction.

17. The method of claim 15, wherein:
either or both of the first reward and the second reward comprise a respective number of reward points, and
the dispensing of the reward to the recipient comprises adding the respective number of reward points to an account balance of reward points having been earned by the recipient.

18. The method of claim 15, wherein:
each of the description of the first reward and the description of the second reward is associated with a value of the respective reward represented by a respective number of reward points, and
the method further comprises:
acquiring an approval to approve the reward before dispensing the reward to the recipient, the approval being based on a combined consideration of the value of the respective reward and an account balance of reward points having been earned by the recipient.

19. The method of claim 15, wherein:
first reward request is further associated with one or more tasks completed by the recipient, and
the method further comprises:
acquiring an approval to approve the reward before dispensing the reward to the recipient, the approval determined based on the one or more completed tasks.

20. A reward-enhanced learning system, comprising:
a learning console through which a student attempts to complete a task;
a reward dispensing machine having a recipient identification device; and
a software configured to store a pre-determined list of reward preferences of the student, a task history recording one or more tasks having been completed by the student, and a reward history recording one or more rewards having been dispensed to the student,
wherein:
the learning console is configured to send a completion notification to a smartphone executing the smartphone app, the completion notification indicating a completion of the task by the student when the student completes the task,
the smartphone app is configured, after the smartphone receiving the completion notification, to determine a personalized reward for the student based on the pre-determined list of reward preferences, to request a permission to dispense the personalized reward to the student from a user of a smartphone executing the smartphone app, and to send a dispensing request to the reward dispensing machine after receiving the permission from the user through the smartphone, and
the reward dispensing machine is configured to dispenses the personalized reward to the student after receiving the dispensing request and when the recipient identification device identifies a physical presence of the student within a proximity of the reward dispensing machine.
